(19) United States
(12) Patent Application Publication
(10) Pub. No.: US 2025/0023032 A1
(43) Pub. Date: Jan. 16, 2025

(54) LITHIUM-COATED ANODE PARTICLES AND METHODS OF PRODUCING THE SAME

(71) Applicant: NanoXplore Inc., Montreal (CA)

(72) Inventors: Nima MOGHIMIAN, Saint Laurent (CA); Soroush NAZARPOUR, Saint-Laurent (CA)

(21) Appl. No.: 18/901,517

(22) Filed: Sep. 30, 2024

Related U.S. Application Data
(63) Continuation of application No. PCT/CA2023/050445, filed on Mar. 31, 2023.
(60) Provisional application No. 63/326,334, filed on Apr. 1, 2022.

(51) Int. Cl. H01M 4/36; H01M 4/38; H01M 4/48; H01M 4/62; H01M 10/42

(52) U.S. Cl. CPC H01M 4/366; H01M 4/382; H01M 4/386; H01M 4/483; H01M 4/625; H01M 10/4235

(57) ABSTRACT

Embodiments described herein relate to anode particles coated with lithium, and methods of producing the same. In some aspects, a method can include melting lithium and a first plurality of graphene flakes together to form a suspension, coating an anode particle with the suspension to form a lithiated particle, the anode particle coated with a second plurality of graphene flakes, and applying a pressure to the lithiated particle. In some embodiments, the method can include heating the lithiated particle. Heating and application of pressure can facilitate diffusion of lithium toward a center region of the lithiated particle. In some embodiments, the method can further include coating the anode particle with the second plurality of graphene flakes. In some embodiments, the anode particle can include silicon, a silicon alloy, silicon oxide, and/or silicon dioxide.

### CROSS-REFERENCE TO RELATED APPLICATIONS

This application is a bypass continuation application, which claims priority to International Application No. PCT/CA2023/050445, filed Mar. 31, 2023, which claims priority and benefit of U.S. Provisional Application No. 63/326,334, filed Apr. 1, 2022 and entitled “Lithium-Coated Anode Particles and Methods of Producing the Same,” the entire disclosures of which are hereby incorporated by reference herein in their entirety.

### TECHNICAL FIELD

Embodiments described herein relate to anode particles coated with lithium, and methods of producing the same.

### BACKGROUND

Lithium-ion batteries often have low first cycle coulombic efficiency. Silicon anodes can have poor cycle life performance due to expansion of silicon and loss of electrolyte. Hindering the expansion of the silicon can at least partially alleviate these problems.

### SUMMARY

Embodiments described herein relate to anode particles coated with lithium, and methods of producing the same. In some aspects, a method can include melting lithium and a first plurality of graphene flakes together to form a suspension, coating an anode particle with a second plurality of graphene flakes, coating the anode particle with the suspension to form a lithiated particle, and applying a pressure to the lithiated particle. In some embodiments, the method can include heating the lithiated particle. Heating and application of pressure can facilitate diffusion of lithium toward a center region of the lithiated particle. In some embodiments, the method can further include coating the anode particle with the second plurality of graphene flakes. In some embodiments, the anode particle can include silicon, a silicon alloy, silicon oxide, and/or silicon dioxide. In some embodiments, the method can further include ejecting a stream of the suspension from a nozzle.

### BRIEF DESCRIPTION OF THE DRAWINGS

FIG. 1 is a block diagram of a lithiated anode particle, according to an embodiment.

FIG. 2 is an illustration of a lithiated anode particle, according to an embodiment.

FIG. 3 is a block diagram of a method of producing a lithiated anode particle, according to an embodiment.

FIGS. 4A-4E illustrate a method of producing a lithiated anode particle, according to an embodiment.

### DETAILED DESCRIPTION

Embodiments described herein relate to lithium-coated anode particles. Lithium can form a shell around an anode particle and diffuse into the interior of the particles. In some embodiments, the anode particles can include silicon, a silicon alloy, silicon dioxide (SiO₂), silicon oxide (SiO), or any combination thereof. Graphene flakes in the lithium shell can also improve conductivity and can physically protect the lithium shell and the anode particle. Such particles can be produced via dry thermo-electro-mechanical processes for lithiation and controlled diffusion of lithium. Applying alternating current during the production of such particles forces multiple cycles of lithiation and de-lithiation that closely mimics the actual charge and discharge cycles inside the anode.

Electronic treatment methods described herein can develop a path of lithium diffusion into and out of the anode particle without loss of electrolyte or creation of an SEI layer. Placement of the anode in a heated chamber during electronic treatment can facilitate and accelerate diffusion of lithium toward the center region of the anode particle. Application of pressure during the electronic treatment can ensure good electrical contact among anode particles and between anode particles and voltage sources. Alternating current in a dry system with adjustable frequency and adjustable duration provides good control over lithiation and delithiation that can be fine-tuned for any combination of particle sizes and ratios for lithium, silicon, and graphene. The migration of lithium ions into silicon can leave more graphene flakes on the surface of the anode particle. This creates a gradient of graphene concentration, where the surface of the anode particles has a greater graphene content than the center region of the anode particles.

In some embodiments, the graphene flakes described herein can have properties the same or substantially similar to the graphene flakes described in U.S. Pat. No. 9,469,542 (the '542 patent”), filed Dec. 22, 2015 and titled “Large Scale Production of Thinned Graphite, Graphene, and Graphite-Graphene Composites,” the entire disclosure of which is hereby incorporated by reference.

As used herein, the term “crystalline graphite” or “precursor crystalline graphite” refers to graphite-based material of a crystalline structure with a size configured to allow ball milling in a ball milling jar. For example, the crystalline graphite can be layered graphene sheets with or without defects, such defects comprising vacancies, interstitials, line defects, etc. The crystalline graphite may come in diverse forms, such as but not limited to ordered graphite including natural crystalline graphite, pyrolytic graphite (e.g., highly ordered pyrolytic graphite (HOPG)), graphite fiber, graphite rods, graphite minerals, graphite powder, flake graphite, any graphitic material modified physically and/or chemically to be crystalline, and/or the like. As another example, the crystalline graphite can be graphite oxide.

As used herein, the term “thinned graphite” refers to crystalline graphite that has had its thickness reduced to a thickness from about a single layer of graphene to about 1,200 layers, which is roughly equivalent to about 400 nm. As such, single layer graphene sheets, few-layer graphene (FLG) sheets, and in general multi-layer graphene sheets with a number of layers about equal to or less than 1,200 graphene layers can be referred as thinned graphite.

As used herein, the term “few-layer graphene” (FLG) refers to crystalline graphite that has a thickness from about 1 graphene layer to about 10 graphene layers.

As used herein, the term “lateral size” or “lateral sheet size” relates to the in-plane linear dimension of a crystalline material. For example, the linear dimension can be a radius, diameters, width, length, diagonal, etc., if the in-plane shape of the material can be at least approximated as a regular geometrical object (e.g., circle, square, etc.). If the in-plane shape of the material cannot be modeled by regular geometrical objects relatively accurately, the linear dimension can be expressed by characteristic parameters as is known in the art (e.g., by using shape or form factors).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

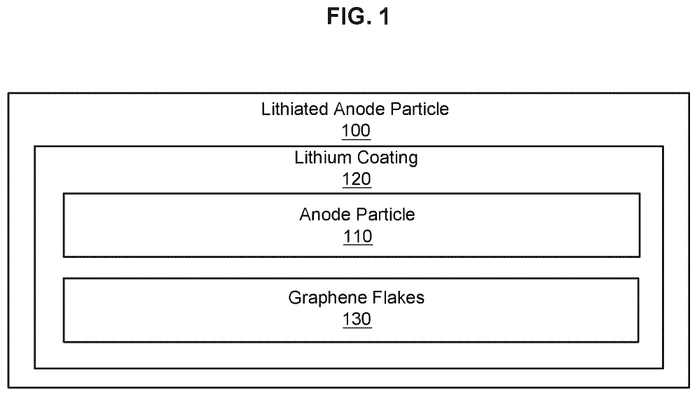

FIG. 1 is a block diagram of a lithiated anode particle 100, according to an embodiment. As shown, the lithiated anode particle 100 includes an anode particle 110 with a lithium coating 120 disposed thereon. The lithium coating 120 includes graphene flakes 130 disposed therein.

In some embodiments, the anode particle 110 can be composed of silicon, SiO₂, SiO, or any combination thereof. In some embodiments, the anode particle 110 can have a particle size of at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, or at least about 950 nm. In some embodiments, the anode particle 110 can have a particle size of no more than about 1 μm, no more than about 950 nm, no more than about 900 nm, no more than about 850 nm, no more than about 800 nm, no more than about 750 nm, no more than about 700 nm, no more than about 650 nm, no more than about 600 nm, no more than about 550 nm, no more than about 500 nm, no more than about 450 nm, no more than about 400 nm, no more than about 350 nm, no more than about 300 nm, or no more than about 250 nm. Combinations of the above-referenced particle sizes are also possible (e.g., at least about 200 nm and no more than about 1 μm or at least about 300 nm and no more than about 900 nm), inclusive of all values and ranges therebetween. In some embodiments, the anode particle 110 can have a particle size of about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1 μm.

The lithium coating 120 includes lithium and is disposed around an outside surface of the anode particle 110. At least a portion of the lithium coating 120 can diffuse into the anode particle 110. In some embodiments, the lithium coating 120 can include one or more additional metals for alloying. In some embodiments, the additional metals can include aluminum, copper, zirconium, bismuth, arsenic, tin, silicon, antimony, carbon, or any combination thereof.

The graphene flakes 130 are incorporated into the lithium coating 120. In some embodiments, the graphene flakes 130 can be incorporated into the anode particle 110. In some embodiments, the graphene flakes 130 can be present in the lithiated anode particle 100 in a weight ratio of no more than about 1:50 graphene:lithium, no more than about 1:60 graphene:lithium, no more than about 1:70 graphene:lithium, no more than about 1:80 graphene:lithium, no more than about 1:90 graphene:lithium, no more than about 1:100 graphene:lithium, no more than about 1:110 graphene:lithium, no more than about 1:120 graphene:lithium, no more than about 1:130 graphene:lithium, no more than about 1:140 graphene:lithium, no more than about 1:150 graphene:lithium, no more than about 1:160 graphene:lithium, no more than about 1:170 graphene:lithium, no more than about 1:180 graphene:lithium, no more than about 1:190 graphene:lithium, no more than about 1:200 graphene:lithium, no more than about 1:210 graphene:lithium, no more than about 1:220 graphene:lithium, no more than about 1:230 graphene:lithium, no more than about 1:240 graphene:lithium, or no more than about 1:250 graphene:lithium, inclusive of all values and ranges therebetween. In some embodiments, the graphene flakes 130 can be present in the lithiated anode particle 100 in a weight ratio of no more than about 1:100 graphene:silicon, no more than about 1:110 graphene:silicon, no more than about 1:120 graphene:silicon, no more than about 1:130 graphene:silicon, no more than about 1:140 graphene:silicon, no more than about 1:150 graphene:silicon, no more than about 1:160 graphene:silicon, no more than about 1:170 graphene:silicon, no more than about 1:180 graphene:silicon, no more than about 1:190 graphene:silicon, or no more than about 1:200 graphene:silicon, inclusive of all values and ranges therebetween.

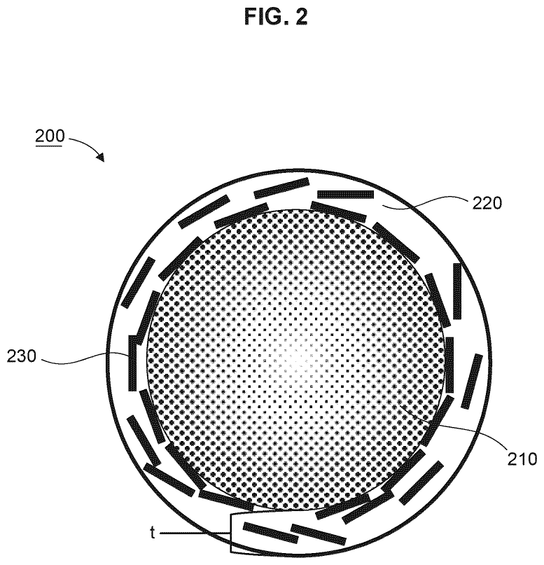

FIG. 2 is an illustration of a lithiated anode particle 200, according to an embodiment. As shown, the lithiated anode particle 200 includes an anode particle 210 with a lithium coating 220 disposed thereon. The lithium coating 220 includes graphene flakes 230 disposed therein. In some embodiments, the anode particle 210, the lithium coating 220, and the graphene flakes 230 can be the same or substantially similar to the anode particle 110, the lithium coating 120, and the graphene flakes 130, as described above with reference to FIG. 1. Thus, certain aspects of the anode particle 210, the lithium coating 220, and the graphene flakes 230 are not described in greater detail herein.

The anode particle 210 is porous, such that the lithium coating 220 can diffuse therein. In some embodiments, the anode particle 210 can have a porosity of at least about 1%, at least about 2%, at least about 3%, at least about 4%, at least about 5%, at least about 6%, at least about 7%, at least about 8%, at least about 10%, at least about 15%, at least about 20%, at least about 25%, at least about 30%, at least about 35%, at least about 40%, or at least about 45%. In some embodiments, the anode particle 210 can have a porosity of no more than about 50%, no more than about 45%, no more than about 40%, no more than about 35%, no more than about 30%, no more than about 25%, no more than about 20%, no more than about 15%, no more than about 10%, no more than about 9%, no more than about 8%, no more than about 7%, no more than about 6%, no more than about 5%, no more than about 4%, no more than about 3%, no more than about 2%. Combinations of the above-referenced porosities are also possible (e.g., at least about 1% and no more than about 50% or at least about 10% and no more than about 25%), inclusive of all values and ranges therebetween. In some embodiments, the anode particle 210 can have a porosity of about 1%, about 2%, about 3%, about 4%, about 5%, about 6%, about 7%, about 8%, about 10%, about 15%, about 20%, about 25%, about 30%, about 35%, about 40%, about 45%, or about 50%. In some embodiments, the anode particle 210 can include silicon, SiO₂, SiO, or any combination thereof. In some embodiments, the anode particle 210 can include graphite, carbon, tin, nickel, or any combination thereof.

The lithium coating 220 is disposed around the outside surface of the anode particle 210 and has a thickness t. In some embodiments, the thickness t can be at least about 5 nm, at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 110 nm, at least about 120 nm, at least about 130 nm, at least about 140 nm, at least about 150 nm, at least about 160 nm, at least about 170 nm, at least about 180 nm, or at least about 190 nm. Combinations of the above-referenced values for the thickness t are also possible (e.g., at least about 5 nm and no more than about 200 nm or at least about 50 nm and no more than about 150 nm), inclusive of all values and ranges therebetween. In some embodiments, the thickness t can be about 5 nm, about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, or about 200 nm.

The lithium from the lithium coating 220 can be at least partially diffused into the anode particle 210. The gradient of the lithium in the anode particle can be described by the change in lithium concentration per length toward the center region of the anode particle 210. In some embodiments, the gradient of the lithium concentration in the anode particle can be about 0.01 wt %/nm, about 0.02 wt %/nm, about 0.03 wt %/nm, about 0.04 wt %/nm, about 0.05 wt %/nm, about 0.06 wt %/nm, about 0.07 wt %/nm, about 0.08 wt %/nm, about 0.09 wt %/nm, about 0.1 wt %/nm, about 0.2 wt %/nm, about 0.3 wt %/nm, about 0.4 wt %/nm, about 0.5 wt %/nm, about 0.6 wt %/nm, about 0.7 wt %/nm, about 0.8 wt %/nm, about 0.9 wt %/nm, or about 1 wt %/nm, inclusive of all values and ranges therebetween.

In some embodiments, the center region of the anode particle 210 can include a region within about 100 nm, within about 90 nm, within about 80 nm, within about 70 nm, within about 60 nm, within about 50 nm, within about 40 nm, within about 30 nm, within about 20 nm, within about 10 nm, or within about 5 nm of the center of mass of the anode particle 210.

The graphene flakes 230 can be disposed in both the anode particle 210 and the lithium coating 220. In some embodiments, the graphene flakes 230 can have a greater concentration in the lithium coating 220 than in the anode particle 210. In some embodiments, the graphene flakes 230 can have a greater concentration in the anode particle 210 than in the lithium coating 220.

In some embodiments, a protective coating (not shown) can be applied to the outside of the lithium coating 220. The protective coating provides a barrier to prevent oxygen and moisture from penetrating the lithiated anode particle 200, which protects the reactive lithium coating 220 from reacting possible reagents. The protective coating also prevents the lithium coating 220 from reacting until the lithium from the lithium coating 220 diffuses toward the center region of the lithiated anode particle 200. In some embodiments, the protective coating can include a layer of a polymer. In some embodiments, the protective coating can include a carbon-rich resin that can be turned into a conductive carbon via heat and/or carbonization. In some embodiments, the protective coating can include polyethylene, polypropylene, polyvinylpyrrolidone (PVP), polyethylene glycol (PEG), polyvinyl alcohol (PVA), cellulose derivatives such as hydroxypropyl methylcellulose (HPMC), methylcellulose (MC), saturated polymer resin, or any combination thereof.

In some embodiments, the protective coating can have a thickness of at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, or at least about 4 μm. In some embodiments, the protective coating can have a thickness of no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, or no more than about 30 nm. Combinations of the above-referenced thicknesses are also possible (e.g., at least about 20 nm and no more than about 5 μm or at least about 50 nm and no more than about 100 nm), inclusive of all values and ranges therebetween. In some embodiments, the protective coating can have a thickness of about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, or about 5 μm.

In some embodiments, the graphene flakes 230 can have any of the physical properties of the graphene flakes described in the '542 patent. In some embodiments, the graphene flakes 230 can have a lateral dimension of at least about 10 nm, at least about 50 nm, at least about 100 nm, at least about 500 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the graphene flakes 230 can have a lateral dimension of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 5 μm, no more than about 1 μm, no more than about 500 nm, no more than about 100 nm, or no more than about 50 nm. Combinations of the above-referenced lateral dimensions of the graphene flakes 230 are also possible (e.g., at least about 10 nm and no more than about 150 μm or at least about 10 μm and no more than about 100 μm), inclusive of all values and ranges therebetween. In some embodiments, the graphene flakes 230 can have a lateral dimension of about 10 nm, about 50 nm, about 100 nm, about 500 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the graphene flakes 230 can have a thickness of at least about 1 graphene layer, at least about 2 graphene layers, at least about 3 graphene layers, at least about 4 graphene layers, at least about 5 graphene layers, at least about 6 graphene layers, at least about 7 graphene layers, at least about 8 graphene layers, at least about 9 graphene layers, at least about 10 graphene layers, at least about 11 graphene layers, at least about 12 graphene layers, at least about 13 graphene layers, at least about 14 graphene layers, at least about 15 graphene layers, at least about 16 graphene layers, at least about 17 graphene layers, at least about 18 graphene layers, or at least about 19 graphene layers. In some embodiments, the graphene flakes 230 can have a thickness of no more than about 20 graphene layers, no more than about 19 graphene layers, no more than about 18 graphene layers, no more than about 17 graphene layers, no more than about 16 graphene layers, no more than about 15 graphene layers, no more than about 14 graphene layers, no more than about 13 graphene layers, no more than about 12 graphene layers, no more than about 11 graphene layers, no more than about 10 graphene layers, no more than about 9 graphene layers, no more than about 8 graphene layers, no more than about 7 graphene layers, no more than about 6 graphene layers, no more than about 5 graphene layers, no more than about 4 graphene layers, no more than about 3 graphene layers, or no more than about 2 graphene layers. Combinations of the above-referenced thicknesses of the graphene flakes 230 are also possible (e.g., at least about 1 graphene layer and no more than about 20 graphene layers or at least about 5 graphene layers and no more than about 10 graphene layers), inclusive of all values and ranges therebetween. In some embodiments, the graphene flakes 230 can have a thickness of about 1 graphene layer, about 2 graphene layers, about 3 graphene layers, about 4 graphene layers, about 5 graphene layers, about 6 graphene layers, about 7 graphene layers, about 8 graphene layers, about 9 graphene layers, about 10 graphene layers, about 11 graphene layers, about 12 graphene layers, about 13 graphene layers, about 14 graphene layers, about 15 graphene layers, about 16 graphene layers, about 17 graphene layers, about 18 graphene layers, about 19 graphene layers, or about 20 graphene layers.

In some embodiments, the graphene flakes 230 can have an aspect ratio of at least about 50, at least about 100, at least about 500, at least about 1,000, at least about 5,000, at least about 10,000, at least about 20,000, at least about 30,000, or at least about 40,000. In some embodiments, the graphene flakes 230 can have an aspect ratio of no more than about 50,000, no more than about 40,000, no more than about 30,000, no more than about 20,000, no more than about 10,000, no more than about 5,000, no more than about 1,000, no more than about 500, or no more than about 100. Combinations of the above-referenced aspect ratios are also possible (e.g., at least about 50 and no more than about 50,000 or at least about 500 and no more than about 5,000), inclusive of all values and ranges therebetween. In some embodiments, the graphene flakes 230 can have an aspect ratio of about 50, about 100, about 500, about 1,000, about 5,000, about 10,000, about 20,000, about 30,000, about 40,000, or about 50,000.

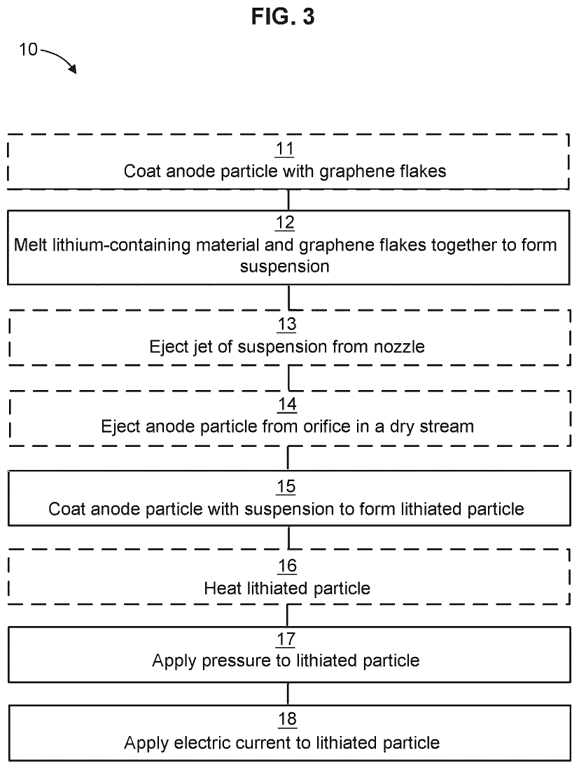

FIG. 3 is a block diagram of a method 10 of producing a lithiated anode particle, according to an embodiment. As shown, the method 10 optionally includes coating an anode particle with graphene flakes at step 11. The method 10 includes melting a lithium-containing material and graphene flakes together to form a suspension at step 12. The method 10 optionally includes ejecting a jet of a suspension from a nozzle at step 13 and ejecting an anode particle from an orifice in a dry stream at step 14. The method 10 further includes coating the anode particle with the suspension to form a lithiated particle at step 15. The method 10 optionally includes heating the lithiated particle at step 16. The method 10 further includes applying pressure to the lithiated particle at step 17 and applying an electric current to the lithiated particle at step 18.

Step 11 is optional and includes coating an anode particle with graphene flakes. In some embodiments, the anode particle can include silicon, SiO₂, SiO, or any combination thereof. In some embodiments, step 11 can include milling metallurgical silicon with graphene to create fine silicon particles with graphene on the surface. The milling can create an electronic attraction between the silicon particles and the graphene flakes, such that the graphene flakes are electronically bonded to the silicon particles. In some embodiments, step 11 can include rotation in a vessel to promote attraction between the graphene flakes and the silicon particles. In some embodiments, the vessel can include a ball mill.

Step 12 includes melting a lithium-containing material and graphene flakes together to form a suspension. In some embodiments, the lithium-containing material can include lithium metal or a lithium-containing alloy. In some embodiments, the lithium-containing material can have a melting temperature of less than about 400° C., less than about 390° C., less than about 380° C., less than about 370° C., less than about 360° C., less than about 350° C., less than about 340° C., less than about 330° C., less than about 320° C., less than about 310° C., less than about 300° C., less than about 290° C., less than about 280° C., less than about 270° C., less than about 260° C., less than about 250° C., less than about 240° C., less than about 230° C., less than about 220° C., less than about 210° C., or less than about 200° C., inclusive of all values and ranges therebetween. In some embodiments, the melting at step 12 can be at a temperature substantially higher than the melting point of the lithium containing material (e.g., higher by at least about 10° C., at least about 20° C., at least about 30° C., at least about 40° C., at least about 50° C., at least about 60° C., at least about 70° C., or at least about 80° C., inclusive of all values and ranges therebetween) in order to facilitate free flowing of the lithium-containing material. Graphene sheets are generally stable up to a temperature of at least about 500° C., so the graphene remains intact during the melting of the lithium-containing material.

In some embodiments, the graphene can be present in the lithium-containing material in a weight ratio of no more than about 1:50 graphene:lithium, no more than about 1:60 graphene:lithium, no more than about 1:70 graphene:lithium, no more than about 1:80 graphene:lithium, no more than about 1:90 graphene:lithium, no more than about 1:100 graphene:lithium, no more than about 1:110 graphene:lithium, no more than about 1:120 graphene:lithium, no more than about 1:130 graphene:lithium, no more than about 1:140 graphene:lithium, no more than about 1:150 graphene:lithium, no more than about 1:160 graphene:lithium, no more than about 1:170 graphene:lithium, no more than about 1:180 graphene:lithium, no more than about 1:190 graphene:lithium, no more than about 1:200 graphene:lithium, no more than about 1:210 graphene:lithium, no more than about 1:220 graphene:lithium, no more than about 1:230 graphene:lithium, no more than about 1:240 graphene:lithium, or no more than about 1:250 graphene:lithium, inclusive of all values and ranges therebetween. In some embodiments, the melting of the lithium-containing material can be in an inert atmosphere with very low humidity (e.g., a glove box, a dry room, etc.) to protect the lithium from oxidation. In some embodiments, the inert atmosphere can include argon, nitrogen, helium, or any combination thereof.

Step 13 is optional and includes ejecting a jet of the suspension from a nozzle. In some embodiments, a first portion of the suspension can be ejected in a first jet from a first nozzle and a second portion of the suspension can be ejected in a second jet from a second nozzle. In some embodiments, the first jet and the second jet can collide with each other.

Step 14 is optional and includes ejecting the anode particle from an orifice in a dry stream. In some embodiments, a dry stream of anode particles can include many anode particles. In some embodiments, the anode particle(s) can be coated with graphene flakes. The dry stream of anode particles can collide with the jet(s) of the suspension, such that the suspension coats the anode particles in the dry stream of anode particles.

Step 15 includes coating the anode particle with the suspension to form the coated particle. In some embodiments, the suspension can be a solid suspension when it coats the anode particle. In some embodiments, the coating can be via the jet(s) of the suspension, as described above with reference to step 13. In some embodiments, the coating can be in an inert environment. In some embodiments, the coating can be in a vessel maintained at a high temperature (e.g., about 10° C. to about 80° C. above the melting temperature of the lithium-containing material) to encourage free flow of the suspension.

In some embodiments, the method 10 can include coating the anode particle with a protective coating. The protective coating can be applied after coating the anode particle with the suspension. In some embodiments, the protective coating can include a layer of a polymer. In some embodiments, the protective coating can include a carbon-rich resin that can be turned into a conductive carbon via heat and/or carbonization. In some embodiments, the protective coating can include polyethylene, polypropylene, polyvinylpyrrolidone (PVP), polyethylene glycol (PEG), polyvinyl alcohol (PVA), cellulose derivatives such as hydroxypropyl methylcellulose (HPMC), methylcellulose (MC), saturated polymer resin, or any combination thereof. In some embodiments, the protective coating can include a conductive polymer. In some embodiments, the protective coating can include polyaniline (PANI), polypyrrole (PPy), or any combination thereof.

In some embodiments, the protective coating can be applied by passing the lithium-coated particle through a polymer melt. In some embodiments, the protective coating can be applied via liquid ejection from a nozzle. In some embodiments, the protective coating can be applied in a manner similar to lithium coating application.

Step 16 is optional and includes heating the lithiated particle. In some embodiments, the heating can be in a heating vessel (e.g., an oven). In some embodiments, the heating can be to a temperature lower than the melting point of the lithium-containing material. In some embodiments, the heating can be to a temperature of at least about 40° C., at least about 45° C., at least about 50° C., at least about 55° C., at least about 60° C., at least about 65° C., at least about 70° C., or at least about 75° C. In some embodiments, the heating can be to a temperature of no more than about 80° C., no more than about 75° C., no more than about 70° C., no more than about 65° C., no more than about 60° C., no more than about 55° C., no more than about 50° C., or no more than about 45° C. Combinations of the above-referenced temperatures are also possible (e.g., at least about 40° C. and no more than about 80° C. or at least about 50° C. and no more than about 70° C.), inclusive of all values and ranges therebetween. In some embodiments, the heating can be to a temperature of least about 40° C., about 45° C., about 50° C., about 55° C., about 60° C., about 65° C., about 70° C., about 75° C., or about 80° C. In some embodiments, the heating can be in intervals or in pulses. In other words, the heat can be applied in time intervals with intervals of no heat application therebetween.

Step 17 includes applying pressure to the lithiated particle. In some embodiments, the pressure can be applied via a press. The pressure can facilitate movement and diffusion of the lithium toward the center region of the anode particle. In some embodiments, the anode particles can be disposed on a platform and the pressure can be applied to the platform. In some embodiments, the anode particles can be disposed on the platform in a layer having a thickness of less than about 10 cm, less than about 9 cm, less than about 8 cm, less than about 7 cm, less than about 6 cm, less than about 5 cm, less than about 4 cm, less than about 3 cm, less than about 2 cm, less than about 1 cm, less than about 9 mm, less than about 8 mm, less than about 7 mm, less than about 6 mm, less than about 5 mm, less than about 4 mm, less than about 3 mm, less than about 2 mm, or less than about 1 mm, inclusive of all values and ranges therebetween. In some embodiments, the pressure applied can be at least about 50 kPa (gauge), at least about 100 kPa, at least about 150 kPa, at least about 200 kPa, at least about 250 kPa, at least about 300 kPa, or at least about 350 kPa. In some embodiments, the pressure applied can be no more than about 400 kPa, no more than about 350 kPa, no more than about 300 kPa, no more than about 250 kPa, no more than about 200 kPa, no more than about 150 kPa, or no more than about 100 kPa. Combinations of the above-referenced pressures are also possible (e.g., at least about 50 kPa and no more than about 400 kPa or at least about 150 kPa and no more than about 300 kPa), inclusive of all values and ranges therebetween. In some embodiments, the pressure applied can be about 50 kPa, about 100 kPa, about 150 kPa, about 200 kPa, about 250 kPa, about 300 kPa, about 350 kPa, or about 400 kPa. In some embodiments, the pressure can be applied in intervals or pulses.

Step 18 includes applying an electric current to the lithiated particle. The application of electric current to the lithiated particle can aid in facilitating movement of lithium toward the center region of the anode particles. In some embodiments, the current can be applied as an alternating current. Alternating current and heat can allow for controlled diffusion of lithium into the anode particles without an abrupt tension. In other words, the alternating current can prevent an internal load from developing in the anode particle. In some embodiments, the current density applied can be at least about −4 mA/cm² (with respect to the surface area of the anode material), at least about −3 mA/cm², at least about −2 mA/cm², at least about −1 mA/cm², at least about 0 mA/cm², at least about 1 mA/cm², at least about 2 mA/cm², or at least about 3 mA/cm². In some embodiments, the current density applied can be no more than about 4 mA/cm², no more than about 3 mA/cm², no more than about 2 mA/cm², no more than about 1 cm², no more than about 0 mA/cm², no more than about −1 mA/cm², no more than about −2 mA/cm², or no more than about −3 mA/cm². Combinations of the above-referenced current densities are also possible (e.g., at least about −4 mA/cm² and no more than about 4 mA/cm² or at least about −1 mA/cm² and no more than about 1 mA/cm²), inclusive of all values and ranges therebetween. In some embodiments, the current density applied can be about −0 mA/cm², about −3 mA/cm², about −2 mA/cm², about −1 mA/cm², about 0 mA/cm², about 1 mA/cm², about 2 mA/cm², about 3 mA/cm², or about 4 mA/cm².

In some embodiments, the current can be applied at a frequency of at least about 0.01 Hz, at least about 0.02 Hz, at least about 0.03 Hz, at least about 0.04 Hz, at least about 0.05 Hz, at least about 0.06 Hz, at least about 0.07 Hz, at least about 0.08 Hz, at least about 0.09 Hz, at least about 0.1 Hz, at least about 0.2 Hz, at least about 0.3 Hz, at least about 0.4 Hz, at least about 0.5 Hz, at least about 0.6 Hz, at least about 0.7 Hz, at least about 0.8 Hz, at least about 0.9 Hz, at least about 1 Hz, at least about 2 Hz, at least about 3 Hz, at least about 4 Hz, at least about 5 Hz, at least about 6 Hz, at least about 7 Hz, at least about 8 Hz, at least about 9 Hz, at least about 10 Hz, at least about 20 Hz, at least about 30 Hz, at least about 40 Hz, at least about 50 Hz, at least about 60 Hz, at least about 70 Hz, at least about 80 Hz, or at least about 90 Hz. In some embodiments, the current can be applied at a frequency of no more than about 100 Hz, no more than about 90 Hz, no more than about 80 Hz, no more than about 70 Hz, no more than about 60 Hz, no more than about 50 Hz, no more than about 40 Hz, no more than about 30 Hz, no more than about 20 Hz, no more than about 10 Hz, no more than about 9 Hz, no more than about 8 Hz, no more than about 7 Hz, no more than about 6 Hz, no more than about 5 Hz, no more than about 4 Hz, no more than about 3 Hz, no more than about 2 Hz, no more than about 1 Hz, no more than about 0.9 Hz, no more than about 0.8 Hz, no more than about 0.7 Hz, no more than about 0.6 Hz, no more than about 0.5 Hz, no more than about 0.4 Hz, no more than about 0.3 Hz, no more than about 0.2 Hz, no more than about 0.1 Hz, no more than about 0.09 Hz, no more than about 0.08 Hz, no more than about 0.07 Hz, no more than about 0.06 Hz, no more than about 0.05 Hz, no more than about 0.04 Hz, no more than about 0.03 Hz, or no more than about 0.02 Hz.

Combinations of the above-referenced frequencies are also possible (e.g., at least about 0.01 Hz and no more than about 100 Hz or at least about 1 Hz and no more than about 10 Hz), inclusive of all values and ranges therebetween. In some embodiments, the current can be applied at a frequency of about 0.01 Hz, about 0.02 Hz, about 0.03 Hz, about 0.04 Hz, about 0.05 Hz, about 0.06 Hz, about 0.07 Hz, about 0.08 Hz, about 0.09 Hz, about 0.1 Hz, about 0.2 Hz, about 0.3 Hz, about 0.4 Hz, about 0.5 Hz, about 0.6 Hz, about 0.7 Hz, about 0.8 Hz, about 0.9 Hz, about 1 Hz, about 2 Hz, about 3 Hz, about 4 Hz, about 5 Hz, about 6 Hz, about 7 Hz, about 8 Hz, about 9 Hz, about 10 Hz, about 20 Hz, about 30 Hz, about 40 Hz, about 50 Hz, about 60 Hz, about 70 Hz, about 80 Hz, about 90 Hz, or about 100 Hz.

In some embodiments, the electric current can be applied for at least about 30 seconds, at least about 1 minute, at least about 5 minutes, at least about 10 minutes, at least about 20 minutes, at least about 30 minutes, at least about 40 minutes, at least about 50 minutes, at least about 1 hour, at least about 2 hours, at least about 3 hours, at least about 4 hours, at least about 5 hours, at least about 10 hours, at least about 12 hours, at least about 24 hours, or at least about 36 hours. In some embodiments, the electric current can be applied for no more than about 48 hours, no more than about 36 hours, no more than about 24 hours, no more than about 12 hours, no more than about 10 hours, no more than about 5 hours, no more than about 4 hours, no more than about 3 hours, no more than about 2 hours, no more than about 1 hour, no more than about 50 minutes, no more than about 40 minutes, no more than about 30 minutes, no more than about 20 minutes, no more than about 10 minutes, no more than about 5 minutes, or no more than about 1 minute. Combinations of the above-referenced durations are also possible (e.g., at least about 30 seconds and no more than about 48 hours or at least about 5 minutes and no more than about 12 hours), inclusive of all values and ranges therebetween. In some embodiments, the electric current can be applied for about 30 seconds, about 1 minute, about 5 minutes, about 10 minutes, about 20 minutes, about 30 minutes, about 40 minutes, about 50 minutes, about 1 hour, about 2 hours, about 3 hours, about 4 hours, about 5 hours, about 10 hours, about 12 hours, about 24 hours, about 36 hours, or about 48 hours.

In some embodiments, the electric current applied at step 18 can be at least partially concurrent with the application of pressure at step 17. In some embodiments, the electric current applied at step 18 can be at least partially concurrent with heating the lithiated particle at step 16. In some embodiments, applying the pressure to lithiated particle at step 17 can occur at least partially concurrent with heating the lithiated particle at step 16.

In some embodiments, the protective coating can be transformed into a conductive coating during the application of the electric current. This transformation can occur via heating and/or a chemical reaction. In other words, the protective coating can be transformed into a conductive coating via application of an electrical current that causes electrical breakdown. In some embodiments, the protective coating can be removed via heating. In some embodiments, the protective coating can be removed via dissolution in a solvent.

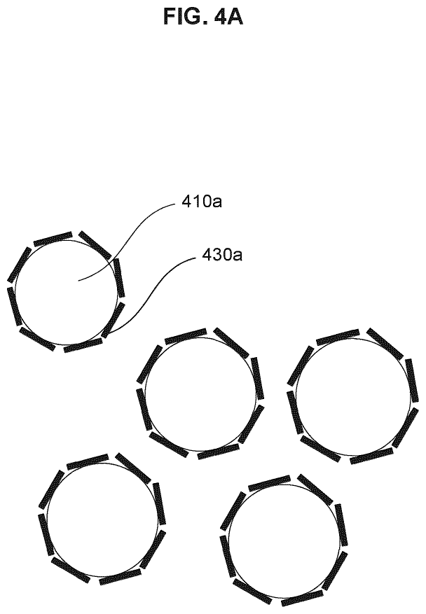

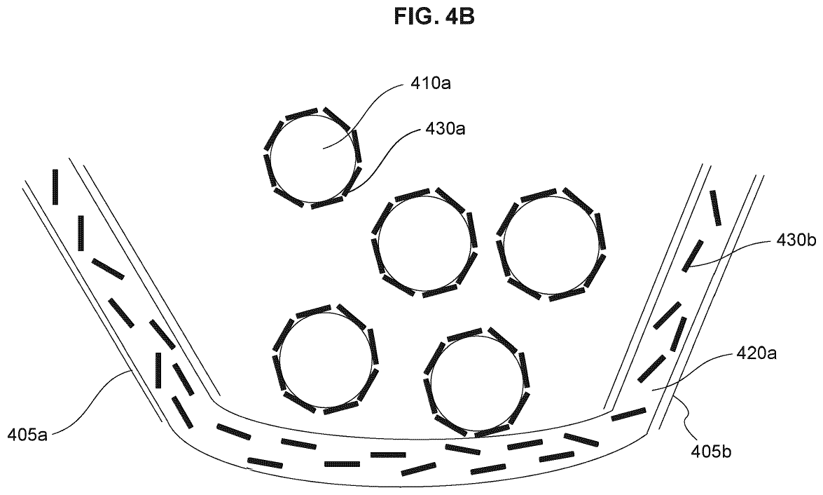

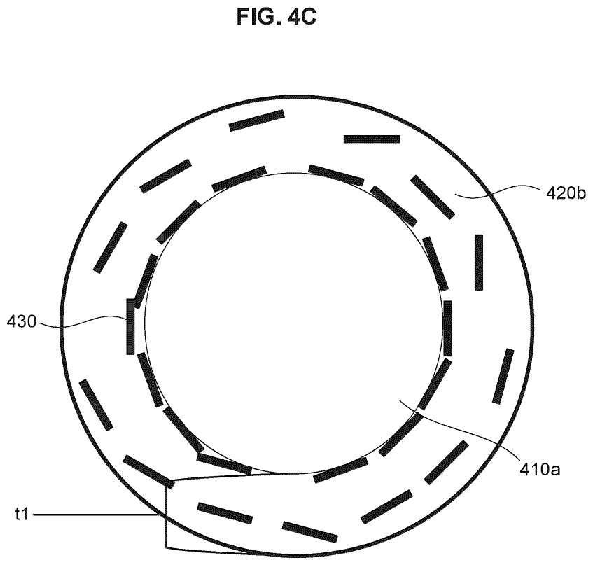

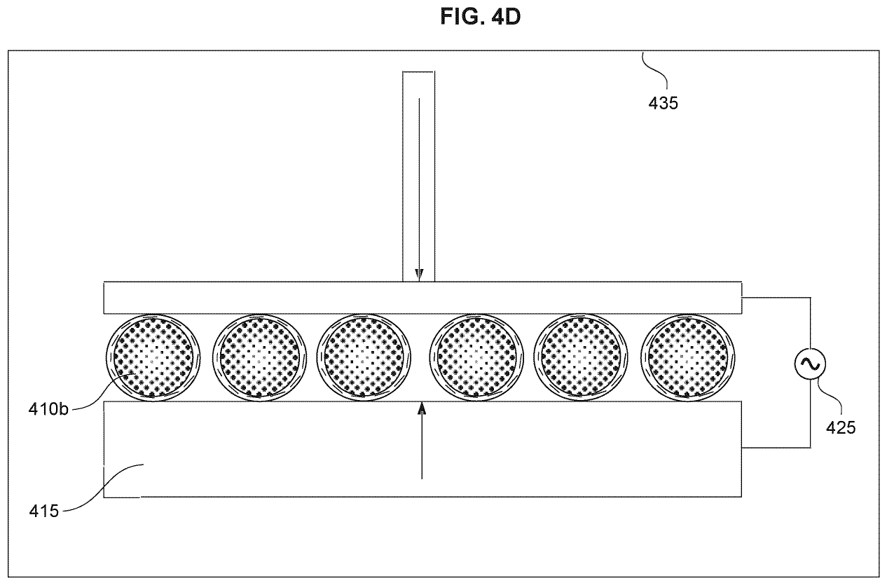

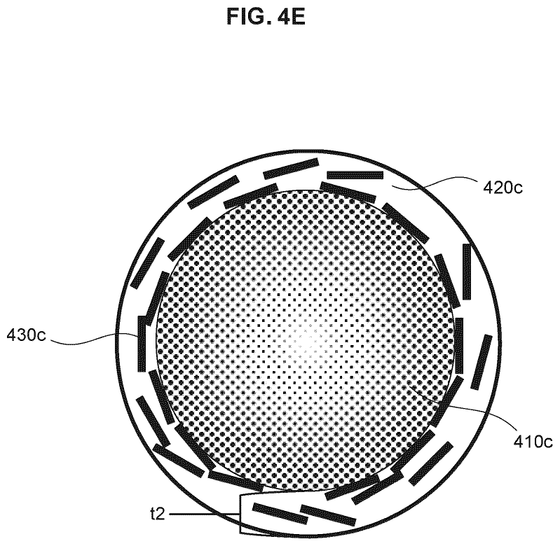

FIGS. 4A-4E illustrate a method of producing a lithiated anode particle, according to an embodiment. FIG. 4A shows anode particles 410a coated with a first plurality of graphene flakes 430a. In some embodiments, the graphene flakes 430a can coat the anode particles 410a via any of the processes described in the method 10, as described above with reference to FIG. 3. FIG. 4B shows a coating process, wherein the melted lithium 420a is ejected in jets from nozzles 405a, 405b. As shown, the jets of the melted lithium 420a ejected from the nozzles 405a, 405b can intersect with one another. The melted lithium 420a includes a second plurality of graphene flakes 430b disposed therein. As shown, the anode particles 410a intersect with the jets of melted lithium 420a, and the melted lithium 420a coats the anode particles 410a to form a coated particle, as shown in FIG. 4C. In some embodiments, the nozzles 405a, 405b can be oriented concentrically. In embodiments with the nozzles oriented concentrically, the nozzle 405a can have a circular cross section and dispense anode particles 410a while the nozzle 405b has an annular cross section around the nozzle 405a and dispenses molten lithium.

As shown, the anode particle 410a is coated with a coating 420b with graphene flakes 430 disposed therein. The coating 420b includes lithium and is a solidified or at least partially solidified form of the melted lithium 420a. Immediately after coating, the coating 420b has a first thickness t1. In some embodiments, the first thickness t1 can be at least about 50 nm, at least about 100 nm, at least about 150 nm, at least about 200 nm, at least about 250 nm, at least about 300 nm, at least about 350 nm, at least about 400 nm, or at least about 450 nm. In some embodiments, the first thickness t1 can be no more than about 500 nm, no more than about 450 nm, no more than about 400 nm, no more than about 350 nm, no more than about 300 nm, no more than about 250 nm, no more than about 200 nm, no more than about 150 nm, or no more than about 100 nm. Combinations of the above-referenced thickness values are also possible (e.g., at least about 50 nm and no more than about 500 nm or at least about 100 nm and no more than about 300 nm), inclusive of all values and ranges therebetween. In some embodiments, the first thickness t1 can be about 50 nm, about 100 nm, about 150 nm, about 200 nm, about 250 nm, about 300 nm, about 350 nm, about 400 nm, about 450 nm, or about 500 nm.

FIG. 4D shows the application of heat, pressure, and electric current to lithiated anode particles 410b to facilitate lithium diffusion into the lithiated anode particles 410b. As shown, the lithiated anode particles 410b are placed on a press 415, where a pressure is applied. A voltage source 425 applies an alternating current across the press 415, such that the current is applied to the lithiated anode particles 410b. The lithiated anode particles 410b and the press 415 are in an oven 435. In some embodiments, the oven 435 can be maintained at a temperature of at least about 40° C., at least about 45° C., at least about 50° C., at least about 55° C., at least about 60° C., at least about 65° C., at least about 70° C., at least about 75° C. In some embodiments, the oven 435 can be maintained at a temperature of no more than about 80° C., no more than about 75° C., no more than about 70° C., no more than about 65° C., no more than about 60° C., no more than about 55° C., no more than about 50° C., or no more than about 45° C. Combinations of the above-referenced temperatures are also possible (e.g., at least about 40° C. and no more than about 80° C.), inclusive of all values and ranges therebetween. In some embodiments, the oven 435 can be maintained at a temperature of about 40° C., about 45° C., about 50° C., about 55° C., about 60° C., about 65° C., about 70° C., about 75° C., or about 80° C.

FIG. 4E shows the fully formed lithiated particle 410c, including a coating 420c and graphene flakes 430c. In some embodiments, the lithiated particle 410c, the coating 420c, and the graphene flakes 430c can be the same or substantially similar to the anode particle 210, the lithium coating 220, and the graphene flakes 230, as described below with respect to FIG. 2. Thus, certain aspects of the lithiated particle 410c, the coating 420c, and the graphene flakes 430c are not described in greater detail herein.

As shown, the coating 420c has a thickness t2, or a post-treatment thickness. The post-treatment thickness t2 can be less than the pre-treatment thickness t1. In some embodiments, the post-treatment thickness t2 can be at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 110 nm, at least about 120 nm, at least about 130 nm, at least about 140 nm, at least about 150 nm, at least about 160 nm, at least about 170 nm, at least about 180 nm, or at least about 190 nm. In some embodiments, the post-treatment thickness t2 can be no more than about 200 nm, no more than about 190 nm, no more than about 180 nm, no more than about 170 nm, no more than about 160 nm, no more than about 150 nm, no more than about 140 nm, no more than about 130 nm, no more than about 120 nm, no more than about 110 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm. Combinations of the above-referenced thickness values are also possible (e.g., at least about 10 nm and no more than about 200 nm or at least about 50 nm and no more than about 150 nm), inclusive of all values and ranges therebetween. In some embodiments, the post-treatment thickness t2 can be about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, or about 200 nm.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
melting lithium and a first plurality of graphene flakes together to form a suspension;
coating an anode particle with a second plurality of graphene flakes;
coating the anode particle with the suspension to form a lithiated particle; and
applying a pressure to the lithiated particle,
wherein the application of pressure facilitates diffusion of lithium toward a center region of the lithiated particle.

2. The method of claim 1, further comprising:
heating the lithiated particle to facilitate diffusion of lithium toward the center region of the lithiated particle.

3. The method of claim 2, wherein coating the anode particle with the second plurality of graphene flakes is done during a milling process.

4. The method of claim 2, wherein heating the lithiated particle is via application of alternating current.

5. The method of claim 4, wherein the alternating current induces lithium diffusion into the anode particle in multiple cycles of diffusion.

6. The method of claim 1, wherein the anode particle includes at least one of silicon, a silicon alloy, silicon oxide, or silicon dioxide.

7. The method of claim 1, further comprising:
ejecting a stream of the suspension from a nozzle.

8. The method of claim 7, wherein the nozzle is a first nozzle and the stream is a first stream, the method further comprising:
ejecting a second stream of the suspension from a second nozzle; and
ejecting the anode particle from an orifice in a dry stream.

9. The method of claim 8, wherein the first stream merges with the second stream to form a barrier of the suspension, and the anode and the dry stream collides with the barrier of the suspension to coat the anode particle.

10. The method of claim 1, wherein at least about 99% of the graphene flakes have a thickness of less than about 20 atomic layers.

11. The method of claim 1, wherein the melting of the lithium is at a temperature of at least about 10° C. greater than a melting point of lithium, such that the melted lithium flows easily.

12. The method of claim 1, wherein the heating is to a temperature of about 40° C. to about 80° C.

13. The method of claim 1, further comprising:
coating the lithiated particle with a protective coating, the protective coating configured to prevent penetration of oxygen and water into the lithiated particle.

14. The method of claim 13, wherein the protective coating is composed of at least one of polyethylene, polypropylene, polyvinylpyrrolidone (PVP), polyethylene glycol (PEG), polyvinyl alcohol (PVA), a cellulose derivative, hydroxypropyl methylcellulose (HPMC), methylcellulose (MC), or saturated polymer resin.

15. A lithiated anode particle, comprising:
a porous anode particle;
a lithium metal coating disposed on the porous anode particle, the lithium metal coating having a first concentration of lithium at an outside surface of the porous anode particle and a second concentration of lithium at a center region of the porous anode particle, the first concentration of lithium greater than the second concentration of lithium; and
a plurality of graphene flakes disposed around an outside surface of the porous anode particle.

16. The lithiated anode particle of claim 15, wherein the anode particle includes at least one of silicon, a silicon alloy, silicon oxide, or silicon dioxide.

17. The lithiated anode particle of claim 15, wherein the anode particle has a particle size of between about 300 nm and about 900 nm.

18. The lithiated anode particle of claim 15, wherein the graphene flakes are present in the lithiated anode particle at a weight ratio of no more than about 1:50 graphene to porous anode particle.

19. The lithiated anode particle of claim 15, further comprising:
a protective coating disposed on the lithium metal coating, the protective coating configured to prevent oxygen and/or moisture from penetrating the lithiated anode particle.

20. The lithiated anode particle of claim 19, wherein the protective coating has a thickness between about 20 nm and about 100 nm.

21. The lithiated anode particle of claim 20, wherein the protective coating is composed of at least one of polyethylene, polypropylene, polyvinylpyrrolidone (PVP), polyethylene glycol (PEG), polyvinyl alcohol (PVA), a cellulose derivative, hydroxypropyl methylcellulose (HPMC), methylcellulose (MC), saturated polymer resin, a conductive polymer, polyaniline (PANI), or polypyrrole (PPy).

22. A method, comprising:
coating an anode particle with a first plurality of graphene flakes;
coating the anode particle with a suspension to form a lithiated particle, the suspension including a second plurality of graphene flakes suspended in lithium;
applying a protective coating to the lithiated particle, the protective coating configured to prevent penetration of oxygen and/or water into the lithiated particle;
heating the lithiated particle; and
applying a pressure to the lithiated particle;
wherein the heating and application of pressure facilitate diffusion of lithium toward a center region of the lithiated particle.

23. The method of claim 22, wherein the protective coating is composed of at least one of polyethylene, polypropylene, polyvinylpyrrolidone (PVP), polyethylene glycol (PEG), polyvinyl alcohol (PVA), a cellulose derivative, hydroxypropyl methylcellulose (HPMC), methylcellulose (MC), saturated polymer resin, a conductive polymer, polyaniline (PANI), or polypyrrole (PPy).
